(19) United States
(12) Patent Application Publication
(10) Pub. No.: US 2015/0279305 A1
(43) Pub. Date: Oct. 1, 2015

(54) DISPLAY DEVICE

(71) Applicant: Samsung Display Co., Ltd., Yongin-City (KR)

(72) Inventors: JAEHYUN CHO, Seoul (KR); Sung-Jin HONG, Hwaseong-si (KR); JaeWoong KANG, Jeonju-si (KR); JAE BYUNG PARK, Seoul (KR); SeYoung SONG, Hwaseong-si (KR)

(21) Appl. No.: 14/607,196

(22) Filed: Jan. 28, 2015

(30) Foreign Application Priority Data
Mar. 27, 2014 (KR) 10-2014-0035964

(51) Int. Cl. G09G 5/00; G09G 5/18

(52) U.S. Cl. CPC G09G 5/00; G09G 5/18

(57) ABSTRACT

A display device includes pixels connected to gate lines and data lines to display an image based on first and second sub-frames and a data driver which generates first data voltages during the first sub-frame and second data voltages having a polarity opposite to that of the first data voltages during the second sub-frame. The pixels connected to odd-numbered gate lines of the gate lines receive the first data voltages through the data lines in response to first gate signals provided through the odd-numbered gate lines during the first sub-frame, and the pixels connected to even-numbered gate lines of the gate lines receive the second data voltages through the data lines in response to second gate signals provided through the even-numbered gate lines during the second sub-frame.

This application claims priority to Korean Patent Application No. 10-2014-0035964, filed on Mar. 27, 2014, and all the benefits accruing therefrom under 35 U.S.C. §119, the content of which in its entirety is herein incorporated by reference.

### BACKGROUND

1. Field

The disclosure relates to a display device. More particularly, the disclosure relates to a display device, in which a data voltage is applied to a display panel in a field sequential driving manner.

2. Description of the Related Art

A display device typically includes a display panel to display an image and gate and data drivers to drive the display panel. The display panel may include gate lines, data lines, and pixels connected to the gate lines and the data lines. The gate lines may receive gate signals from the gate driver, and the data lines may receive data voltages from the data driver. The pixels receive the data voltages through the data lines in response to the gate signals provided through the gate lines. The pixels display grayscales corresponding to the data voltages, and thus desired images are displayed.

Such a display device may include a controller to control the gate and data drivers. The controller controls the gate and data drivers to allow the gate signals and the data voltages to be applied to the pixels.

### SUMMARY

The disclosure provides a display device in which a data voltage is applied to a display panel in a field sequential driving manner.

An exemplary embodiment of the invention provide a display device including a plurality of pixels connected to a plurality of gate lines and a plurality of data lines to display an image based on first and second sub-frames and a data driver which generates first data voltages during the first sub-frame and second data voltages having a polarity opposite to a polarity of the first data voltages during the second sub-frame, where the pixels connected to odd-numbered gate lines of the gate lines receive the first data voltages through the data lines in response to first gate signals provided through the odd-numbered gate lines during the first sub-frame, and the pixels connected to even-numbered gate lines of the gate lines receive the second data voltages through the data lines in response to second gate signals provided through the even-numbered gate lines during the second sub-frame.

According to exemplary embodiments of a display device described herein, the data voltages are applied to the display panel in the field sequential driving manner, such that the visibility of the display device is substantially improved.

### BRIEF DESCRIPTION OF THE DRAWINGS

The above and other feature of the invention will become apparent by describing in further detail exemplary embodiments thereof with reference to the accompanying drawings, in which:

FIG. 1 is a block diagram showing an exemplary embodiment of a display device according the invention;

FIGS. 2 to 5 are views showing operations of an exemplary embodiment of a display device to apply data voltages to a display panel in a field sequential driving manner;

FIG. 6 is a signal timing diagram showing an operation of an exemplary embodiment of a display device in a field sequential driving manner, according to the invention;

FIG. 7 is a circuit diagram showing an exemplary embodiment of a gate driver shown in FIG. 1 according to the invention; and

FIG. 8 is a signal timing diagram showing an operation of an exemplary embodiment of a display device including the gate driver shown in FIG. 7.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings herein.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

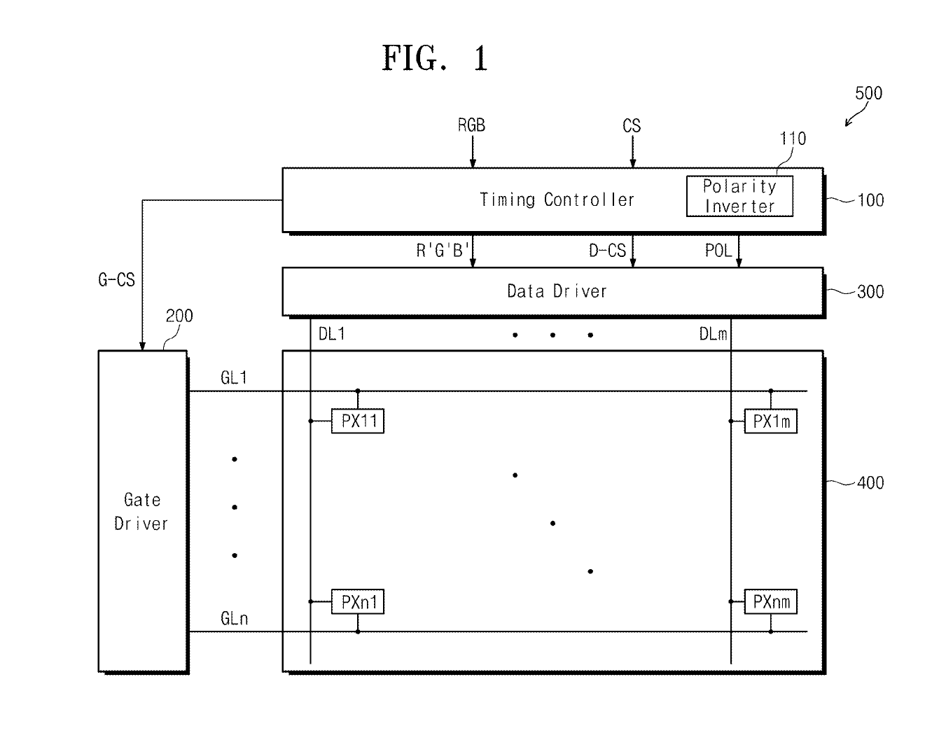

FIG. 1 is a block diagram showing an exemplary embodiment of a display device according to the invention.

Referring to FIG. 1, an exemplary embodiment of a display device 500 includes a timing controller 100, a gate driver 200, a data driver 300 and a display panel 400.

The timing controller 100 receives image signals RGB and control signals CS from outside of the display apparatus 500. The timing controller 100 converts a data format of the image signals RGB to a data format corresponding to or appropriate to interface between the data driver 300 and the timing controller 100. The converted image signals R′G′B′ are applied to the data driver 300.

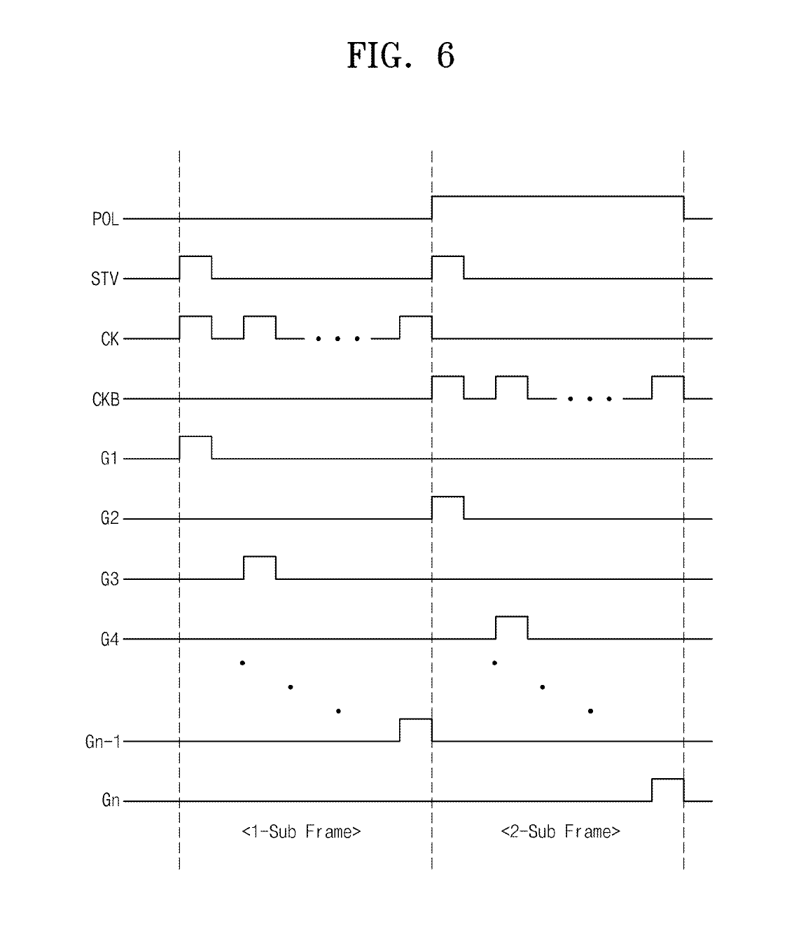

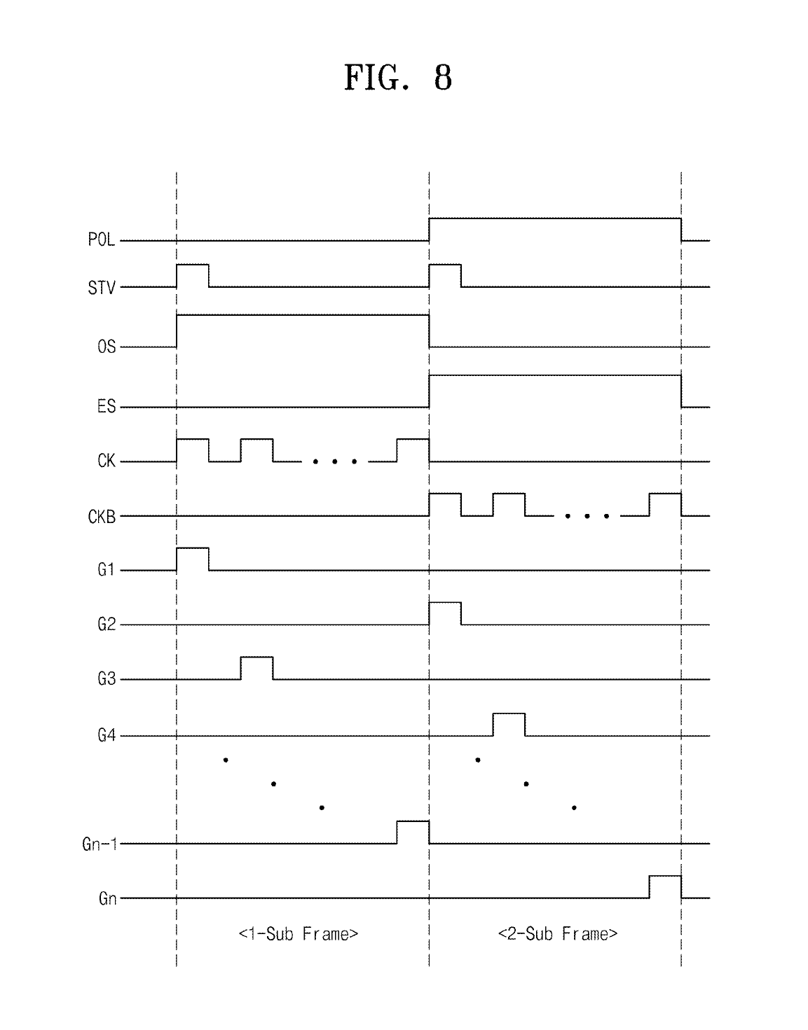

The timing controller 100 generates a gate control signal G-CS and a data control signal D-CS based on the control signals CS. The data control signal D-CS may include an output start signal and a horizontal start signal, for example. The gate control signal G-CD may include a vertical start signal, a vertical clock bar signal, an odd-numbered control signal, and an even-numbered control signal, for example. The gate control signal G-CS will be described in greater detail with reference to FIGS. 6 and 8. The timing controller 100 applies the data control signal D-CS to the data driver 300 and applies the gate control signal G-CS to the gate driver 200.

In an exemplary embodiment, the display device 500 may display an image based on a field sequential driving manner corresponding to a frequency set. In one exemplary embodiment, for example, the display device 500 may display one image on the basis of two frames, e.g., every two frames or two sub-frames of one unit frame, differently from a conventional display device that displays one image on the basis of one frame, e.g., every one frame, but not being limited thereto or thereby. In an exemplary embodiment, the one image may be displayed through the display device 500 every predetermined number of frames based on the frequency set.

The timing controller 100 generates the gate control signal G-CS and the data control signal D-CS on the basis of two frames corresponding to the frequency set.

The timing controller 100 includes a polarity inverter 110. The polarity inverter 110 generates an inversion driving signal POL to control a polarity of the data voltages applied to the display panel 400. In an exemplary embodiment, the polarity of the data voltages output from the data driver 300 is changed in response to the inversion driving signal POL. The timing controller 100 applies the inversion driving signal POL generated by the polarity inverter 110 to the data driver 300.

The gate driver 200 outputs gate signals in response to the gate control signal G-CS provided from the timing controller 100. In an exemplary embodiment, the gate driver 200 outputs the gate signals on the basis of the two frames corresponding to the frequency set.

The data driver 300 receives the data control signal D-CS and the inversion driving signal POL from the timing controller 100. The data driver 300 converts the converted image signals R′G′B′ to data voltages in response to the data control signal D-CS. The data driver 300 applies the data voltages to the display panel 400 in response to the inversion driving signal POL.

The display panel 400 includes a plurality of gate lines GL1 to GLn, a plurality of data lines DL1 to DLm, and a plurality of pixels PX11 to PXnm arranged substantially in a matrix form. Herein, each of n and m are a natural number greater than 1. The gate lines GL1 to GLn extend substantially in a row direction and cross the data lines DL1 to DLm extending substantially in a column direction. The gate lines GL1 to GLn are electrically connected to the gate driver 200 and receive the gate signals, respectively, based on the two frames, e.g., every two frames. The data lines DL1 to DLm are electrically connected to the data driver 300 and receives the data voltages. Each of the pixels PX11 to PXnm is connected to a corresponding gate line of the gate lines GL1 to GLn and a corresponding data line of the data lines DL1 to DLm. The pixels PX11 to PXnm are sequentially scanned in the unit of row by the gate signals.

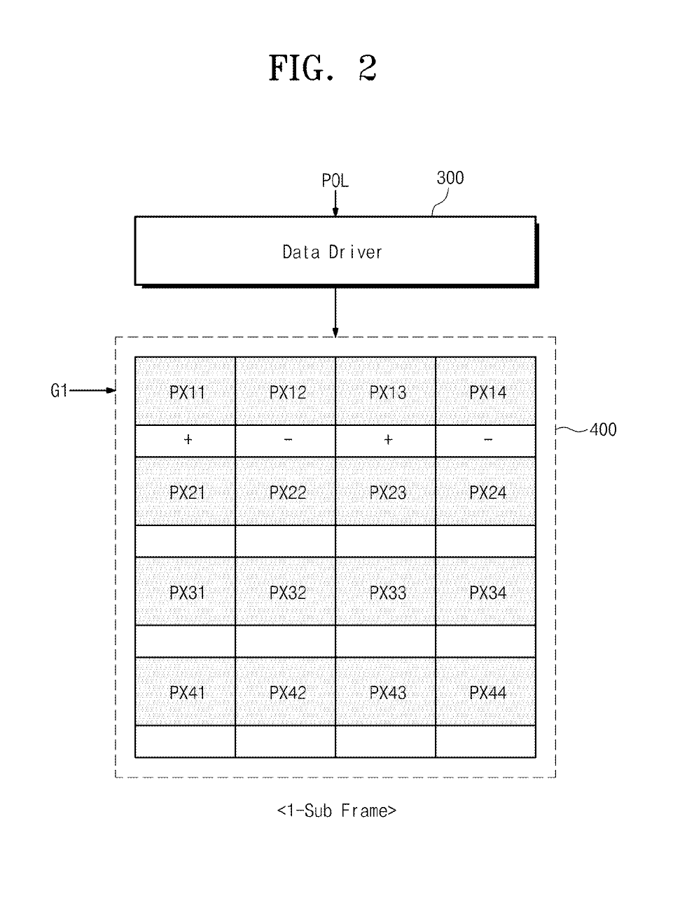

FIGS. 2 to 5 are views showing operations of an exemplary embodiment of a display device to apply the data voltages to the display panel in the field sequential driving manner.

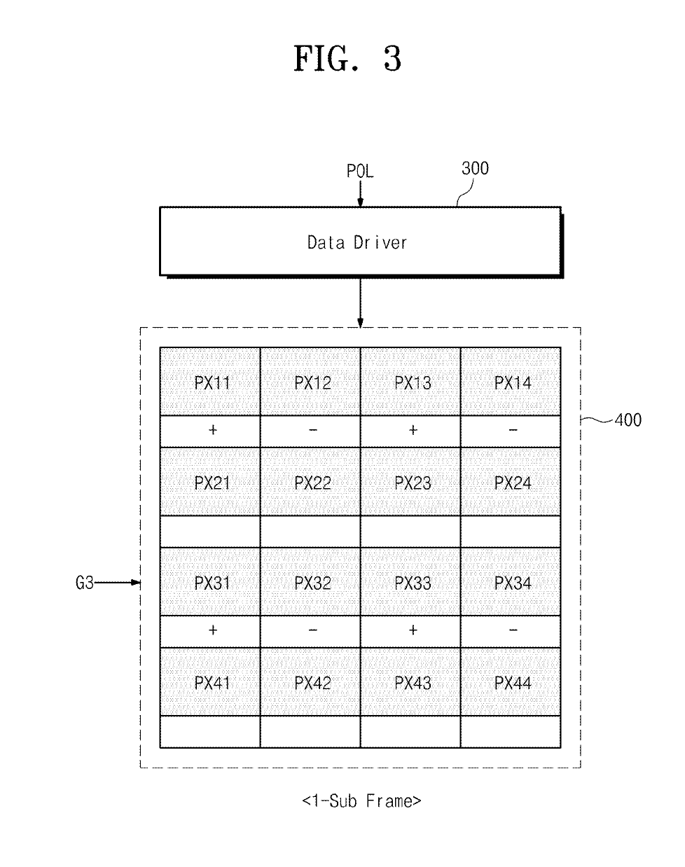

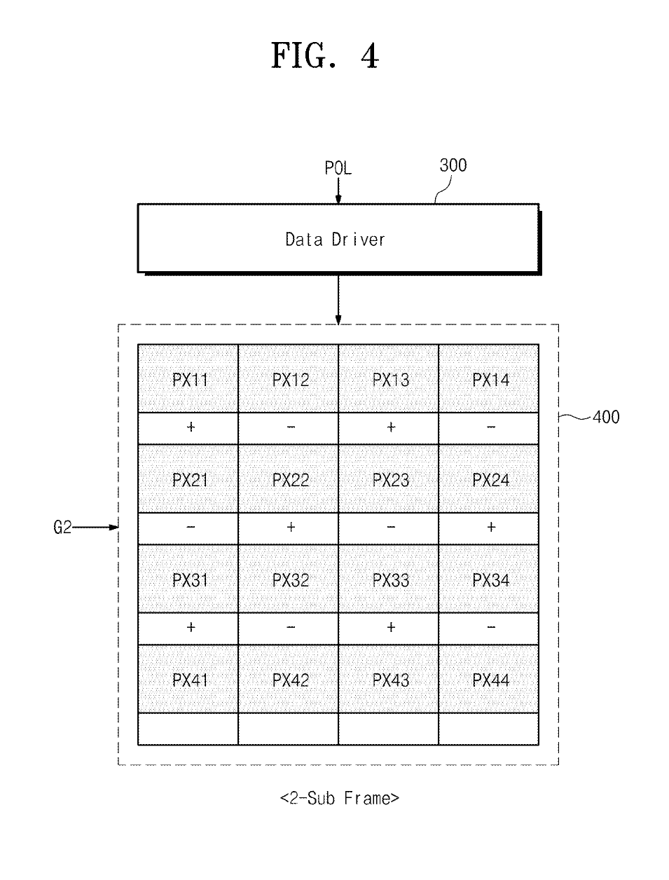

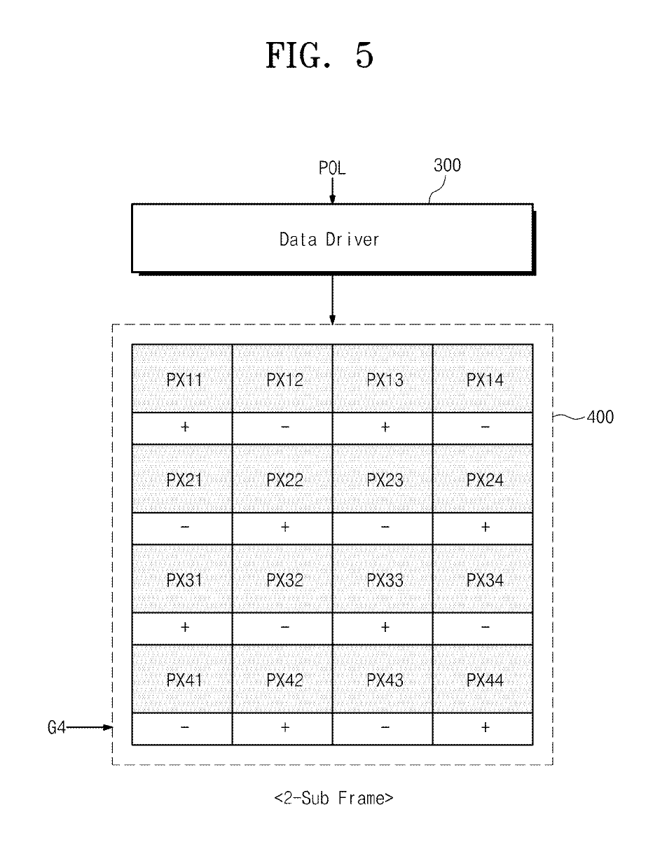

In an exemplary embodiment, the display device 500 (refer to FIG. 1) displays one image based on two sub-frames, e.g., a first sub-frame 1-SF and a second sub-frame 2-SF. In such an embodiment, the first and second sub-frames 1-SF and 2-SF correspond to a unit frame for displaying one image. FIGS. 2 and 3 show the operations of the display panel 400 during the first sub-frame 1-SF, and FIGS. 4 and 5 show the operations of the display panel 400 during the second sub-frame 2-SF.

FIGS. 2 to 5 shows the pixels PX11 to PX44 arranged in a 4×4 matrix form to explain the operations of the display panel 400 in the first and second sub-frames 1-SF and 2-SF, but the operations of the display panel 400 should not be limited to such pixels PX11 to PX44.

In an exemplary embodiment, as shown in FIGS. 3 to 5, first row pixels PX11, PX12, PX13 and PX14 are connected to a first gate line GL1, second row pixels PX21, PX22, PX23 and PX24 are connected to a second gate line GL2, third row pixels PX31, PX32, PX33 and PX34 are connected to a third gate line GL3, and fourth row pixels PX41, PX42, PX43 and PX44 are connected to a fourth gate line GL4.

In such an embodiment, the display panel 400 receives the data voltages in a dot-inversion driving manner.

When the data driver outputs the data voltages in the dot-inversion driving manner, the polarity of the data voltage applied to the display panel is inverted every gate line. When the data driver outputs the data voltages in the dot-inversion driving manner, the pixels connected to the first gate line and the first data line may receive a positive (+) data voltage from the data driver in response to the first gate signal. Then, the pixels connected to the second gate line and the second data line may receive a negative (−) data voltage from the data driver in response to the second gate signal.

As described above, the data driver repeatedly applies the data voltages to each pixel of the display panel in an order of positive (+) and negative (−), or negative (−) and positive (+) every gate line. When the polarity of the data voltages output from the data driver is inverted every gate line, heat may be generated in the data driver due to a difference in voltage between the data voltages having opposite polarities.

In an exemplary embodiment, the polarity inverter 110 (refer to FIG. 1) generates the inversion driving signal POL based on the first and second sub-frames 1-SF and 2-SF. The polarity of the data voltages applied to the display panel 400 is controlled by the inversion driving signal POL generated based on the first and second sub-frames 1-SF and 2-SF.

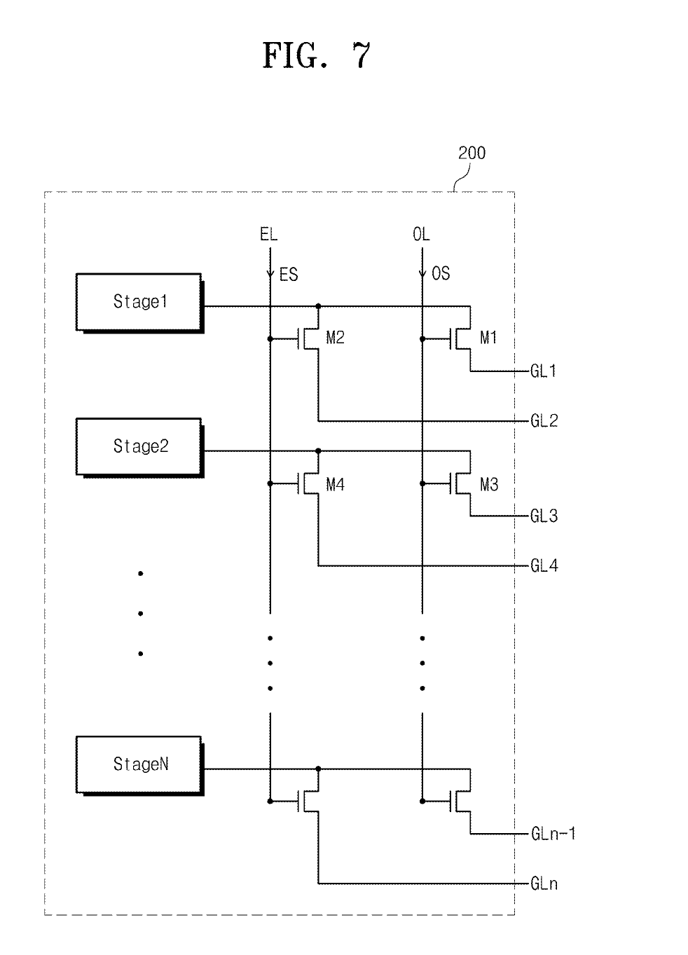

The gate driver 200 sequentially applies the gate signals to odd-numbered gate lines GL1, GL3, . . . , GLn−1 (refer to FIG. 1) of the gate lines during the first sub-frame 1-SF. The gate driver 200 sequentially applies the gate signals to even-numbered gate lines GL2, GL4, . . . , GLn (refer to FIG. 1) of the gate lines during the second sub-frame 2-SF. The operation of the gate driver 200 will be described in greater detail with reference to FIG. 7.

Referring to FIGS. 2 and 3, the data driver 300 receives the inversion driving signal POL from the polarity inverter 110, which is generated based on the first sub-frame 1-SF. In the first sub-frame 1-SF, the data driver 300 outputs the data voltages, in which the polarity thereof is not changed, in response to the inversion driving signal POL generated based on the first sub-frame 1-SF. The gate driver 200 sequentially applies first and third gate signals G1 and G3 to the first and third gate lines GL1 and GL3.

In an exemplary embodiment, as shown in FIG. 2, the gate driver 200 may apply the first gate signal G1 to the first gate line GL1. The first row pixels PX11, PX12, PX13 and PX14 electrically connected to the first gate line GL1 receive the data voltages from the data driver 300 in response to the first gate signal G1. In such an embodiment, the first row pixels PX11, PX12, PX13 and PX14 receive the positive (+), negative (−), positive (+) and negative (−) data voltages, respectively, based on the dot-inversion driving manner.

Referring to FIG. 3, the gate driver 200 may apply the third gate signal G3 to the third gate line GL3. The third row pixels PX31, PX32, PX33 and PX34 electrically connected to the third gate line GL3 receive the data voltages from the data driver 300 in response to the third gate signal G3. In such an embodiment, the third row pixels PX31, PX32, PX33 and PX34 may receive the positive (+), negative (−), positive (+) and negative (−) data voltages, respectively, based on the dot-inversion driving manner.

In such an embodiment, the data driver 300 applies the data voltages having the same-polarity configuration to each data line during the first sub-frame 1-SF.

Referring to FIGS. 4 and 5, the data driver 300 receives the inversion driving signal POL from the polarity inverter 110, which is generated based on the second sub-frame 2-SF. In an exemplary embodiment, the inversion driving signal POL generated based on the second sub-frame 2-SF may be complementary to the inversion driving signal POL generated based on the first sub-frame 1-SF.

In such an embodiment, the data driver 300 outputs the data voltages, in which the polarity thereof is not changed, in response to the inversion driving signal POL generated based on the second sub-frame 2-SF. The gate driver 200 sequentially applies second and fourth gate signals G2 and G4 to the second and fourth gate lines GL2 and GL4.

In an exemplary embodiment, as shown in FIG. 4, the gate driver 200 may apply the second gate signal G2 to the second gate line GL2. The second row pixels PX21, PX22, PX23 and PX24 electrically connected to the second gate line GL2 receive the data voltages from the data driver 300 in response to the second gate signal G2. In such an embodiment, the second row pixels PX21, PX22, PX23 and PX24 may receive the negative (−), positive (+), negative (−) and positive (+) data voltages, respectively, based on the dot-inversion driving manner.

Referring to FIG. 5, the gate driver 200 may apply the fourth gate signal G4 to the fourth gate line GL4. The fourth row pixels PX41, PX42, PX43 and PX44 electrically connected to the fourth gate line GL4 receive the data voltages from the data driver 300 in response to the fourth gate signal G4. In such an embodiment, the fourth row pixels PX41, PX42, PX43 and PX44 receive the negative (−), positive (+), negative (−), and positive (+) data voltages, respectively, based on the dot-inversion driving manner.

In an exemplary embodiment, the data driver 300 applies the data voltages having the same-polarity configuration to each data line during the second sub-frame 2-SF.

As described above, in an exemplary embodiment, the polarity of the data voltages applied to the display panel 400 from the data driver 300 is changed once during the first and second sub-frames 1-SF and 2-SF. Accordingly, the heat generated in the data driver 300, which is caused by the difference in voltage between the polarities of the data voltages, may be substantially reduced.

FIG. 6 is a signal timing diagram showing the operation of an exemplary embodiment of the display device in the field sequential driving manner, according to the invention.

Referring to FIGS. 1 and 6, in an exemplary embodiment, the timing controller 100 outputs the inversion driving signal POL based on the first and second sub-frames 1-SF and 2-SF. In such an embodiment, the timing controller 100 generates the vertical start signal STV to output the gate signals G1 to Gn during each of the first and second sub-frames 1-SF and 2-SF.

During the first sub-frame 1-SF, the timing controller 100 may apply the inversion driving signal POL having a low level to the data driver 300. In such an embodiment, the polarity of the data voltages output from the data driver 300 is not changed during the first sub-frame 1-SF. The gate driver 200 sequentially outputs the gate signals G2, G3, . . . , Gn−1 to the odd-numbered gate lines in response to the clock signal CK during the first sub-frame 1-SF. Hereinafter, the gate signals G1, G3, . . . , Gn−1 (hereinafter, referred to as “GO”) applied to the odd-numbered gate lines will be referred to as first gate signals GO.

The clock signal CK is generated in response to the vertical start signal STV generated by the timing controller 100 during the first sub-frame 1-SF. The vertical start signal STV may be included in the gate control signal G-CS output from the timing controller 100. In an exemplary embodiment, the clock bar signal CKB may be maintained at a low level during the first sub-frame 1-SF. In such an embodiment, the gate signals G2, G4, . . . , Gn applied to the even-numbered gate lines are not output during the first sub-frame 1-SF. Hereinafter, the gate signals G2, G4, . . . , Gn (hereinafter, referred to as “GE” applied to the even-numbered gate lines will be referred to as second gate signals GE. In an exemplary embodiment, the gate signals G1 to Gn are grouped into the first gate signals GO and the second gate signals GE based on the first and second sub-frames 1-SF and 2-SF.

In an exemplary embodiment, the vertical start signal STV may be transited to a high level when the clock signal CK is activated, but it should not be limited thereto or thereby. In an alternative exemplary embodiment, the vertical start signal STV may be transited to the high level before the clock signal CK is activated.

Then, during the second sub-frame 2-SF, the timing controller 100 may apply the inversion driving signal POL having a high level to the data driver 300. In such an embodiment, the polarity of the data voltages output from the data driver 300 is changed during the second sub-frame 2-SF. The gate driver 200 sequentially outputs the second gate signals GE to the even-numbered gate lines in response to the clock bar signal CKB during the second sub-frame 2-SF. The clock bar signal CKB is generated in response to the vertical start signal STV output from the timing controller 100 during the second sub-frame 2-SF. In an exemplary embodiment, the clock signal CK may be maintained at the low level during the second sub-frame 2-SF. In such an embodiment, the first gate signals GO applied to the odd-numbered gate lines are not output from the gate driver 200 during the second sub-frame 2-SF.

As described above, in an exemplary embodiment, the gate driver 300 outputs the first gate signals GO applied to the odd-numbered gate lines during the first sub-frame 1-SF and outputs the second gate signals GE applied to the even-numbered gate lines during the second sub-frames 2-SF. Therefore, the pixels PX11 to PXnm included in the display panel 400 are applied with the data voltages in the dot-inversion driving manner during the unit frame, i.e., during the first and second sub-frames 1-SF and 2-SF.

FIG. 7 is a circuit diagram showing an exemplary embodiment of the gate driver 200 shown in FIG. 1 according to the invention.

Referring to FIG. 7, an exemplary embodiment of the gate driver 200 includes a plurality of stages Stage1 to StageN. In such an embodiment, each stage is connected to two gate lines to output two gate signals. In such an embodiment, the number of the stages included in the gate driver 200 is a half of the number of the gate lines.

In an exemplary embodiment, as shown in FIG. 7, a first stage Stage1 is connected to a drain terminal of a first transistor M1. The first transistor M1 includes a gate terminal connected to an odd-numbered control line OL and a source terminal connected to the first gate line GL1. In such an embodiment, the first stage Stage1 is connected to a drain terminal of a second transistor M2. The second transistor M2 includes a gate terminal connected to an even-numbered control line EL and a source terminal connected to the second gate line GL2.

In such an embodiment, a second stage Stage2 is connected to a drain terminal of a third transistor M3. The third transistor M3 includes a gate terminal connected to the odd-numbered control line OL and a source terminal connected to the third gate line GL3. In such an embodiment, the second stage Stage2 is connected to a drain terminal of a fourth transistor M4. The fourth transistor M4 includes a gate terminal connected to the even-numbered control line EL and a source terminal connected to the fourth gate line GL4. The other stages have substantially the same configuration as the first and second stages S1 and S2. Thus, for convenience of description, only the first and second stages Si and S2 will be described in greater detail with reference to FIG. 7.

The gate driver 200 outputs the gate signals G1 to Gn (refer to FIG. 6) based on the first and second sub-frames 1-SF and 2-SF as described in FIG. 6.

During the first sub-frame 1-SF, an odd-numbered control signal OS is maintained at an activation state and an even-numbered control signal ES is maintained at an inactivation state. The first transistor M1 outputs the first gate signal G1 output from the first stage Stage1 to the first gate line GL1 in response to the odd-numbered control signal OS maintained at the activation state. Then, the third transistor M3 outputs the third gate signal G3 output from the second stage Stage2 to the third gate line GL3 in response to the odd-numbered control signal OS maintained at the activation state. In an exemplary embodiment, the odd-numbered control signal OS may be included in the gate control signal G-CS output from the timing controller 100 (refer to FIG. 1).

During the second sub-frame 2-SF, the odd-numbered control signal OS is transited to the inactivation state and the even-numbered control signal ES is transited to the activation state after the first sub-frame 1-SF is finished. In an exemplary embodiment, the odd-numbered control signal OS and the even-numbered control signal ES are complementary to each other. The second transistor M2 outputs the second gate signal G2 output from the first stage Stage1 to the second gate line GL2 in response to the even-numbered control signal ES maintained at the activation state. Then, the fourth transistor M4 outputs the fourth gate signal G4 output from the second stage Stage2 to the fourth gate line GL4 in response to the even-numbered control signal ES maintained at the activation state. Similar to the odd-numbered control signal OS, the even-numbered control signal ES may be included in the gate control signal G-CS output from the timing controller 100.

FIG. 8 is a signal timing diagram showing the operation of an exemplary embodiment of the display device including the gate driver shown in FIG. 7.

The timing diagram shown in FIG. 8 may be substantially the same as the timing diagram shown in FIG. 6 except that the odd-numbered control signal OS and the even-numbered control signal ES are added. Accordingly, for convenience of description, the odd-numbered control signal OS and the even-numbered control signal ES will be mainly described with reference to FIG. 8.

Referring to FIG. 8, the timing controller 100 (refer to FIG. 1) controls the odd-numbered control signal OS to be activated during the first sub-frame 1-SF. The timing controller 100 controls the even-numbered control signal ES to be inactivated during the first sub-frame 1-SF. When the odd-numbered control signal OS is activated, the gate driver 200 (refer to FIG. 7) outputs the first gate signals GO in response to the clock signal CK.

Then, the timing controller 100 controls the even-numbered control signal ES to be activated and controls the odd-numbered control signal OS to be inactivated during the second sub-frame 2-SF. When the even-numbered control signal ES is activated, the gate driver 200 outputs the second gate signals GE in response to the clock bar signal CKB.

As described above, in an exemplary embodiment, the number of the stages S1 to SN is reduced to the half of the number of the gate lines GL1 to GLn of the gate driver 200. Thus, a manufacturing cost of the display device may be reduced.

Although the exemplary embodiments of the invention have been described, it is understood that the invention should not be limited to these exemplary embodiments but various changes and modifications may be made by one ordinary skilled in the art within the spirit and scope of the invention as hereinafter claimed.

What is claimed is:

1. A display device comprising:
a plurality of pixels connected to a plurality of gate lines and a plurality of data lines to display an image based on first and second sub-frames; and
a data driver which generates first data voltages during the first sub-frame and second data voltages having a polarity opposite to the first data voltages during the second sub-frame,
wherein
the pixels connected to odd-numbered gate lines of the gate lines receive the first data voltages through the data lines in response to first gate signals provided through the odd-numbered gate lines during the first sub-frame, and
the pixels connected to even-numbered gate lines of the gate lines receive the second data voltages through the data lines in response to second gate signals provided through the even-numbered gate lines during the second sub-frame.

2. The display device of claim 1, wherein
the polarity of the first data voltages applied to the data lines is inverted every data line, and
the polarity of the second data voltage applied to the data lines is inverted every data line.

3. The display device of claim 1, further comprising:
a timing controller which generates an inversion driving signal to control the polarity of the first and second data voltages.

4. The display device of claim 3, wherein
the inversion driving signal is inactivated during the first sub-frame, and
the inversion driving signal is activated during the second sub-frame.

5. The display device of claim 4, wherein the data driver generates the first data voltages in response to the inversion driving signal which is inactivated during the first sub-frame.

6. The display device of claim 4, wherein the data driver generates the second data voltages in response to the inversion driving signal which is activated during the second sub-frame.

7. The display device of claim 1, wherein the data driver outputs the first and second data voltages in a dot-inversion driving manner.

8. The display device of claim 1, wherein a display panel thereof displays one image based on the first and second sub-frames.

9. The display device of claim 1, further comprising:
a gate driver which outputs the first and second gate signals,
wherein
the gate driver applies the first gate signals to the odd-numbered gate lines during the first sub-frame, and
the gate driver applies the second gate signals to the even-numbered gate lines during the second sub-frame.

10. The display device of claim 9, wherein
the gate driver comprises a plurality of stages, and
each of the stages outputs at least one first gate signal of the first gate signals and at least one second gate signal of the second gate signals.

11. The display device of claim 10, further comprising:
a timing controller which outputs an odd-numbered control signal and an even-numbered control signal to output the first and second gate signals,
wherein the odd-numbered control signal and the even-numbered control signal are complementary to each other.

12. The display device of claim 11, wherein the gate driver sequentially applies the first gate signals to the odd-numbered gate lines in response to the odd-numbered control signal during the first sub-frame.

13. The display device of claim 11, wherein the gate driver sequentially applies the second gate signals to the even-numbered gate lines in response to the even-numbered control signal during the second sub-frame.

14. The display device of claim 11, wherein
each of the stages is connected to a first transistor and a second transistor, and
the first transistor outputs the at least one first gate signal of the first gate signals in response to the odd-numbered control signal.

15. The display device of claim 14, wherein the second transistor outputs the at least one second gate signal of the second gate signals in response to the even-numbered control signal.
